(19) United States
(12) Patent Application Publication
(10) Pub. No.: US 2007/0030584 A1
(43) Pub. Date: Feb. 8, 2007

(54) Compressed domain commercial detect/skip

(75) Inventor: Lowell L. Winger, Waterloo (CA)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 11/195,049

(22) Filed: Aug. 2, 2005

(51) Int. Cl. G11B 5/02

(52) U.S. Cl. 360/55

(57) ABSTRACT

An apparatus comprising an encoder circuit, a recordable medium, and a decoder circuit. The encoder circuit may be configured to generate (i) a first recordable signal and (ii) a second recordable signal in response to an input bitstream having program information and commercial information. The recordable medium may be configured to record the first and second recordable signals and present an intermediate signal containing program information and transition information. The decoder circuit may be configured to generate an output signal in response to the intermediate signal. The decoder circuit uses the transition information within the intermediate signal to detect or skip the commercial information.

### FIELD OF THE INVENTION

The present invention relates to video processing generally and, more particularly, to a method and/or apparatus for implementing a compressed domain commercial detect/skip feature.

### BACKGROUND OF THE INVENTION

Conventional commercial skip features are frequently available for VCRs, DVD recorders, personal video recorders (PVRs) and other devices for recording and/or timeshifting video. Conventional solutions work in the sampled (or uncompressed) domain. In particular, conventional approaches work on decoded/raw video and/or audio.

For a digital video recorder (DVR) or personal video recorder (PVR), conventional approaches are inefficient when a raw bitstream is being directly stored to a recordable medium (e.g., a harddrive or a DVD). With such direct recording, a commercial detect system needs to either (a) decode a portion of the entire bitstream (i.e., lookahead) for commercial detection or (b) provide offline/background video decoding with commercial detection. Both conventional approaches are wasteful of resources. In particular, both conventional approaches need the video to be fully decoded in order to perform the commercial detection.

It would be desirable to perform a commercial detect and/or skip either entirely or partially in the compressed domain.

### SUMMARY OF THE INVENTION

The present invention concerns an apparatus comprising an encoder circuit, a recordable medium, and a decoder circuit. The encoder circuit may be configured to generate (i) a first recordable signal and (ii) a second recordable signal in response to an input bitstream having program information and commercial information. The recordable medium may be configured to record the first and second recordable signals and present an intermediate signal containing program information and transition information. The decoder circuit may be configured to generate an output signal in response to the intermediate signal. The decoder circuit uses the transition information within the intermediate signal to detect or skip the commercial information.

The objects, features and advantages of the present invention include providing a commercial detect and/or skip that may (i) operate in the compressed domain, (ii) encode syntax indications in a compressed bitstream, (iii) in some cases, partially decode the bitstream, (iv) avoid unnecessary decoding and/or (v) save resources by reducing and/or eliminating unnecessary decoding.

### BRIEF DESCRIPTION OF THE DRAWINGS

These and other objects, features and advantages of the present invention will be apparent from the following detailed description and the appended claims and drawings in which:

FIG. 1 is a block diagram of the present invention;

FIG. 2 is a block diagram of an alternate embodiment of the present invention; and

FIG. 3 is a block diagram of another alternate embodiment of the present invention.

### DETAILED DESCRIPTION OF THE PREFERRED EMBODIMENTS

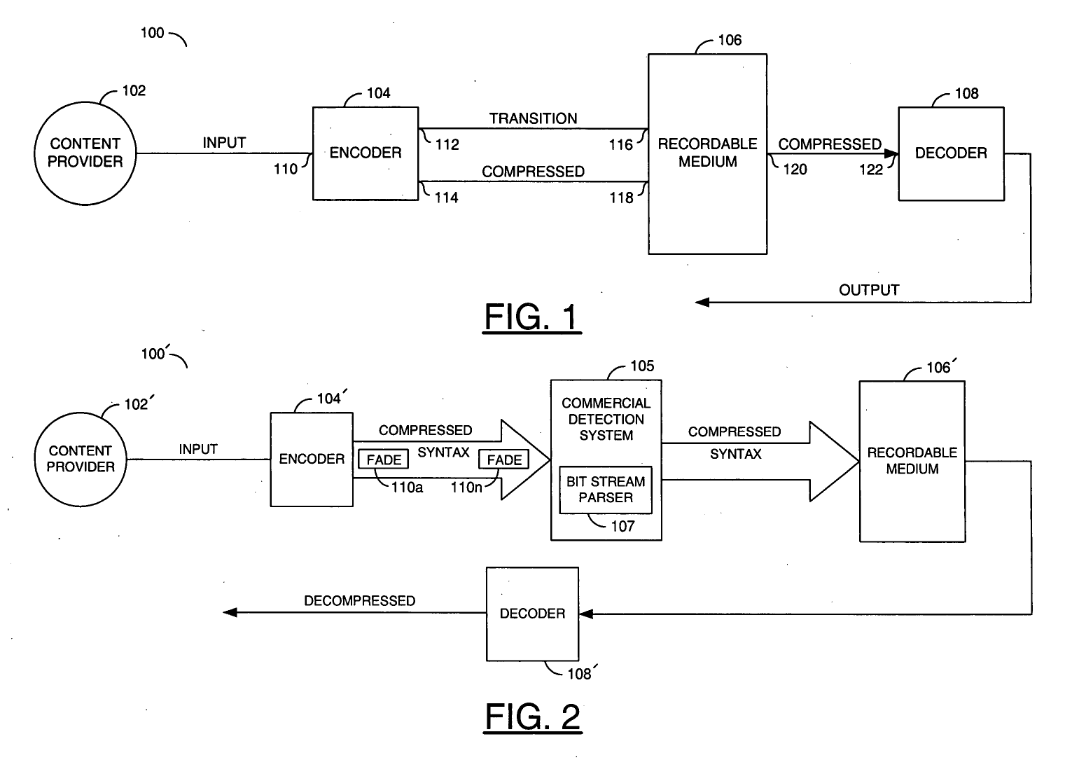

Referring to FIG. 1, a block diagram of a system 100 is shown in accordance with a preferred embodiment of the present invention. The system 100 may be used to perform commercial detection during encoding by using syntax indications. The system 100 generally comprises a block (or circuit) 102, a block (or circuit) 104, a block (or circuit) 106 and a block (or circuit) 108. The circuit 102 may be implemented as a content provider. The circuit 104 may be implemented as an encoder circuit. The circuit 106 may be implemented a recordable medium. The circuit 108 may be implemented as a decoder circuit.

The content provider 102 may provide a signal (e.g., INPUT). The signal INPUT may be an uncompressed audio/video signal. The content provider 102 may be implemented as a cable television service, a satellite provider, an internet provided audio/video stream, or other appropriate content provider. The encoder circuit 104 may have an input 110 that may receive the signal INPUT, an output 112 and an output 114. The output 112 may present a signal (e.g., TRANSITION) to an input 116 of the recordable medium 106. The signal TRANSITION may be used to store information related to commercials. The output 114 may present a signal (e.g., COMPRESSED) to an input 118 of the recordable medium. The signal COMPRESSED may be a compressed audio/video bitstream. The signal COMPRESSED and the signal TRANSITION may be separately stored in the recordable medium 106. The recordable medium 106 may have an output 120 that normally presents the signal COMPRESSED to an input 122 of the decoder 108. The decoder 108 normally presents a signal (e.g., OUTPUT). The signal OUTPUT may be a decompressed audio/video bitstream.

In one example, the recordable medium 106 may be implemented as a hard disk drive. In one example, a plurality of hard disk drives may be implemented. In another example, a recordable DVD may be implemented. The particular type of recordable medium may be varied to meet the design criteria of a particular implementation.

During encoding, side-information is stored as the signal TRANSITION. A personal video recorder (PVR) or a digital video recorder (DVR) may be used with the encoder 104 to detect potential commercial transitions and/or commercials and to store indications along with the compressed audio/video bitstream. Since the signal TRANSITION is stored along with the signal COMPRESSED, a commercial detection and/or skip feature may be implemented in the compressed domain. In particular, the compressed domain normally refers to a signal that is digitally stored and/or transmitted prior to decoding. Various compression standards, such as H.263, H.264, Windows Media, etc. may be used to generate a compressed bitstream.

Referring to FIG. 2, a system 100′ is shown implementing an alternate embodiment of the present invention. The circuit 100′ generally comprises a content provider circuit 102′, an encoder circuit 104′, a block (or circuit) 105, a recordable medium circuit 106′ and a decoder circuit 108′. The encoder 104′ generates the signal COMPRESSED that includes one or more syntax elements that indicate when a commercial starts and ends. The circuit 105 may be implemented as a commercial detection block. The circuit 105 may include a bitstream parser circuit 107.

The system 100′ may use syntax elements encoded in the signal COMPRESSED to indicate a number of fades 110a-110n already present in standard bitstream syntax. The fades 110a-110n may be used to detect commercial transitions. Such commercial transitions may include (i) VC-1 intensity compensation syntax fades to/from a constant graylevel, (ii) H.264/MPEG4-AVC weighted prediction syntax where a bitstream parser extracts the relevant syntax elements from the bitstream, and/or (iii) intensity compensation and/or weighted prediction syntax values. Commercial detection may be implemented using these transitions to avoid completely decoding the compressed bitstream).

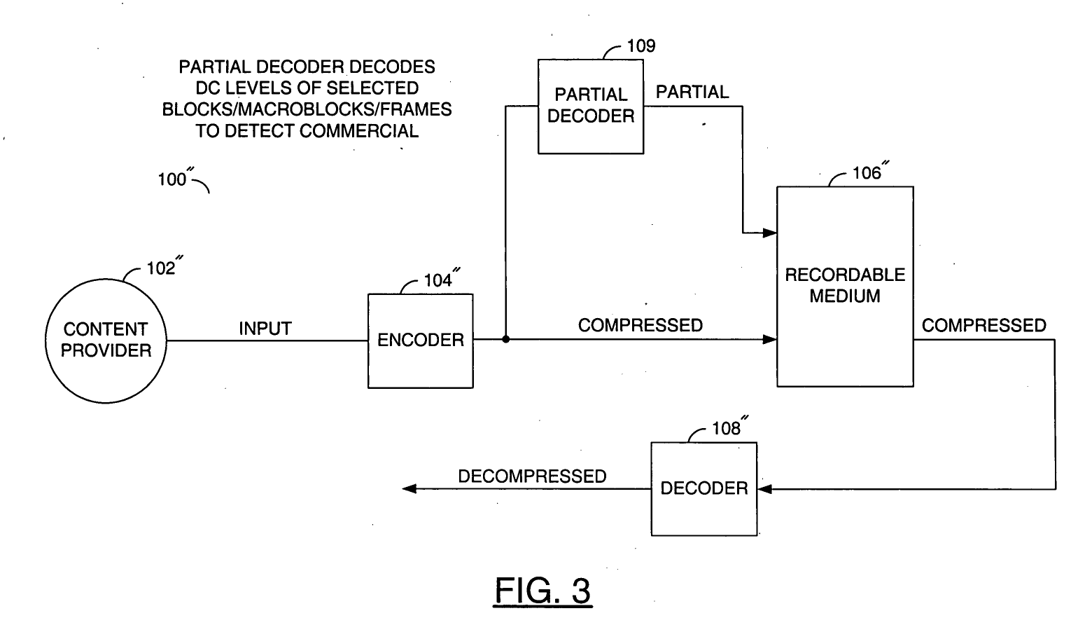

Referring to FIG. 3, a system 100″ is shown comprising a content provider 102″, an encoder 104″, a recordable medium 106″, a decoder 108″ and a partial decoder 109. The system 100″ may be used to partially decode a bitstream. The partial decoder 109 receives the signal COMPRESSED from the encoder 104″. The partial decoder 109 presents a signal (e.g., PARTIAL). The signal PARTIAL generally comprises an uncompressed bitstream at the DC level.

The system 100″ may use partial video decoding to implement commercial detection. The partial decoding may include combination of partial video decoding along with partial audio decoding. The partial decoder 109 may implement a block DC level decode. Examples of such partial decoding include (i) decoding only DC levels of selected blocks/macroblocks/fields/frames, (ii) decoding some percentage of reference-frame macroblocks and/or slices, (iii) decoding some percentage of all macroblocks and/or slices, (iv) decoding some percentage of key (I-frame) macroblocks and/or slices, (v) not performing a full decode either by not decoding all macroblocks and/or frames and/or fields, (iv) and/or not decoding all coefficients (e.g., decoding only the DC of each transform block). In one example, reference frames may be stored at a reduced resolution (e.g., storing DCs only) to save memory bandwidth. In another example, reconstructing only DC block images may be implemented.

The present invention may be used to implement a low-complexity commercial detection on compressed bitstreams. While some embodiments of the present invention use a partial decode, none of the three options need a complete video decode.

The present invention normally allows a lookahead commercial detect, and/or offline/background flagging and classification of commercials. Significant resources may be saved with the present invention in contrast to conventional systems that run a complete decode either well ahead of the currently displayed video (or offline depending on which detection interface is needed).

In one example, the present invention may be implemented without a decoder. For example, the present invention may be implemented as a method for implementing commercial detection on an arbitrary bitstream, such as an H.264 bitstream, an H.263 bitstream, etc. Such an implementation may involve decoding only a small portion of the bitstream. Such an implementation may be used to look at a combination of a “Prediction Weight Table” that is normally specified for each video slice, and one or more macroblock reference indices that indicate what weights from the table to use for motion compensation in an H.264 video stream to detect fades/transitions for commercial detection. In another example, such an implementation may look only at the DC values of the video transform blocks to detect fades/transitions for commercial detection. In another example, such an implementation may look only at the DC values of the audio transform blocks to detect cuts between commercials for commercial detection. In addition, VC-1 intensity-compensation syntax values may be used. VC-1 intensity-compensation syntax values are similar to the H.264 mechanism to indicate that the temporal prediction should be “scaled” or “faded”, making a good indication of a shot or commercial transition point). In general, the present invention may be implemented to not completely decode the video but to look only at coefficient and/or motion vector bitrate and/or macroblock mode decisions from the compressed stream to detect commercial transitions to be used for commercial detection.

The present invention may be modified to be used in a variety of compressed domain commercial detection systems. Commercial detection and skipping (both manual and automated) are becoming more pervasive in the marketplace with the increasing adoption of PVRs. Traditional methods for commercial detection (e.g., looking for fade-to-black in the video coinciding with silent audio to identify commercial transition points) are becoming less successful for automated detection of commercials. Some techniques involve more complex analysis and classification of video content, but trade off additional complexity and cost. Such systems may still not be successful, since as more wide spread countermeasures are being designed by broadcasters to defeat such techniques.

While traditional approaches may continue to be successful for a significant portion of commercial and commercial block detection for some time to come, alternative methods may be implemented to increase successful detection. The compressed domain analysis of the present invention provides many alternative sources of information that may be used for commercial detection. For example, the identification of a video splice point may be implemented through identification of a change in high-level syntax. For example, different encoding strategies may be used for main program and commercials, since each source tends to be generated at a different studio facility. Commercials may be identified in bitstream syntax through the use of different strategies such as (i) scaling lists, (ii) quantization matrices, (iii) picture order count types or patterns, (iv) number of reference frames, (v) use of repeat fields and repeat frames, (vi) group of pictures structure, (vii) user data rates, (viii) scene transition indicators, (ix) recovery point indicators, (x) access unit delimiters, (xi) usage pattern of pan-scan parameters, (xii) film grain models, etc. Such syntax elements may be analyzed to detect changes between program and commercial content.

While H.264 terminology has been used, similar high level syntax from MPEG-2 and VC-1 may also be used in a similar fashion. For example, it is unlikely that a program and an inserted commercial could successfully use similar film grain models without lending a very unnatural look to one of these sources. Since the program and commercial each may have been initially encoded with a different authoring process, even transcoding and splicing these bitstreams together will often not remove all the high-level syntax differences that identify the individual sources.

While the invention has been particularly shown and described with reference to the preferred embodiments thereof, it will be understood by those skilled in the art that various changes in form and details may be made without departing from the spirit and scope of the invention.

1. An apparatus comprising:
an encoder circuit configured to generate (i) a first recordable signal and (ii) a second recordable signal in response to an input bitstream having program information and commercial information;
a recordable medium configured to record said first and second recordable signals and present an intermediate signal containing program information and transition information; and
a decoder circuit configured to generate an output signal in response to said intermediate signal, wherein said decoder circuit uses said transition information within said intermediate signal to detect or skip said commercial information.

2. The apparatus according to claim 1, wherein said intermediate signal comprises a compressed signal.

3. The apparatus according to claim 1, wherein said output signal comprises an uncompressed audio/video signal.

4. The apparatus according to claim 1, wherein said recordable medium comprises a hard disk drive.

5. The apparatus according to claim 1, wherein said recordable medium comprises a plurality of hard disk drives.

6. The apparatus according to claim 1, wherein said recordable medium comprises a solid state storage medium.

7. The apparatus according to claim 1, wherein said recordable medium comprises a recordable DVD.

8. The apparatus according to claim 1, wherein said input bitstream is received from a content provider.

9. The apparatus according to claim 8, wherein said content provider is selected from the group consisting of a cable television feed, a satellite feed, an internet feed and an antenna feed.

10. An apparatus comprising:
an encoder circuit configured to generate a compressed signal having program information and commercial information in response to an input bitstream;
a detect circuit configured to generate a recordable signal in response to said compressed signal;
a recordable medium configured to record said recordable signal and present an intermediate signal containing program information and transition information; and
a decoder circuit configured to generate an output signal in response to said intermediate signal, wherein said decoder uses said transition information within said intermediate signal to detect or skip said commercial information.

11. A method for detecting commercials in a bitstream comprising the steps of:
(A) receiving a bitstream having program information and commercial information;
(B) partially decoding said bitstream to detect one or more transitions; and
(C) determining said commercial information in response to said transitions.

12. The method according to claim 11, further comprising the step of:
decoding only a small portion of the bitstream.

13. The method according to claim 11, further comprising the step of:
looking at a prediction weight table and one or more macroblock reference indices in an H.264 bitstream to detect fades/transitions for commercial detection.

14. The method according to claim 11, further comprising the step of:
looking at only DC values of one or more video transform blocks to detect fades/transitions for commercial detection.

15. The method according to claim 11, further comprising the step of:
looking at only DC values of one or more audio transform blocks to detect cuts between commercials for commercial detection.

16. The method according to claim 11, further comprising the step of:
looking at only coefficient and/or motion vector bitrate and/or macroblock mode decisions from the bitstream to detect commercial transitions to be used for commercial detection.
